(19) United States
(12) Patent Application Publication
(10) Pub. No.: US 2015/0375716 A1
(43) Pub. Date: Dec. 31, 2015

(54) WIPER BLADE

(71) Applicant: KCW Corporation, Daegu (KR)

(72) Inventor: Jae-Hyuck An, Daegu (KR)

(21) Appl. No.: 14/751,781

(22) Filed: Jun. 26, 2015

(30) Foreign Application Priority Data
Jun. 27, 2014 (KR) 1020140079407

(51) Int. Cl. B60S 1/40

(52) U.S. Cl. CPC B60S 1/4003

(57) ABSTRACT

A wiper blade may be provided which is used in both a left hand drive vehicle and a right hand drive vehicle. The wiper blade includes: a connection holder which is formed in the central portion of the wiper blade and is connected to a wiper arm; and an adaptor which is coupled to the connection holder and receives a connector connected directly to the wiper arm. The main lever is formed symmetrically with respect to the connection holder. A direction in which the adaptor is coupled to the main lever is selected according to a steering wheel position of the vehicle.

### CROSS REFERENCE TO RELATED APPLICATIONS

Priority is claimed under 35 U.S.C. §119 to Korean Patent Application No.: 10-2014-0079407 , filed Jun. 27, 2014 , the disclosure of which is incorporated herein by reference in its entirety.

### FIELD OF THE INVENTION

The embodiment relates to a wiper blade, and more particularly to a wiper blade which can be used in both a left hand drive vehicle and a right hand drive vehicle.

### BACKGROUND OF THE INVENTION

In general, a wiper blade removes impurities, snow, rain or the like when driving and prevents a driver's front sight from being deteriorated. In a conventional wiper blade, as a motor drives a link apparatus connected to a wiper arm, the wiper blade performs a repetitive reciprocating action in a fan shape.

The conventional wiper arms for a vehicle have mutually different shapes or sizes in accordance with the manufacturer of the wiper arm or a wiper blade to be connected thereto, so that there is a limit in that only a dedicated wiper can be used. That is, a conventional driving arm for a vehicle is largely divided into a ‘U’-shaped clip type which has a catching structure, a bayonet type in which the driving arm is inserted and fixed in the form of a plug, a pin type which includes a protrusion formed on a side thereof and has a fitting structure by the protrusion, a side hole type which has been developed by Bosch Co., Ltd and in which the driving arm is fitted and coupled to a side of the wiper, an M lock type and a top lock type in which the driving arm is coupled to surround from the upper portion of the wiper. Since such various kinds of the driving arms have mutually different shapes and sizes, there is a limit in that only a dedicated wiper can be used.

Accordingly, the product of the wiper is difficult to standardize, so that the design flexibility of the product decreases and the wiper blades should be manufactured in such a manner as to conform various kinds of the wiper arms respectively. As a result, the manufacturing time and cost of the product are increased. The driver's seat position is different depending on countries. Therefore, the shape of the wiper blade of the right hand driver vehicle with the right driver's seat position is different from the shape of the wiper blade of the left hand driver vehicle with the left driver's seat position. Also, for the purpose of increasing the rise prevention performance of the wiper, the wiper is formed asymmetrically according to the shape of a spoiler.

Meanwhile, with regard to the conventional wiper blade, through use of a pin or a rivet, a yoke member and an auxiliary lever are rotatably coupled to each other, and the auxiliary levers are rotatably coupled to each other. In order to reduce frictional resistance of the coupling portion, a space, etc., having a small friction coefficient is coupled to the coupling portion. Therefore, the number of parts constituting one wiper blade is as many as 20 and at least 15 . Since the conventional wiper blade uses a metallic main lever and a metallic auxiliary lever, the wiper blade is heavy.

The wiper blade which has a lot of parts and large weight gives a load to the wiper arm as well as a glass surface of the vehicle when the wiper blade is installed in the vehicle. As a result, breakdown may occur and the life span of the product may be shortened. Accordingly, a light wiper blade having an excellent assemblability is required to be developed.

### SUMMARY OF THE INVENTION

One embodiment is a wiper blade 1 which is used in both a left hand drive vehicle and a right hand drive vehicle. The wiper blade 1 includes: a connection holder 400 which is formed in the central portion of the wiper blade 1 and is connected to a wiper arm; and an adaptor 50, 150 and 250 which is coupled to the connection holder 400 and receives a connector 60, 160 and 260 connected directly to the wiper arm. The main lever 40 is formed symmetrically with respect to the connection holder 400. A direction in which the adaptor 50, 150 and 250 is coupled to the main lever 40 is selected according to the a steering wheel position of the vehicle.

The adaptor 50, 150 and 250 is attachable to and detachable from the wiper blade 1 and is replaceable according to the connector 60, 160 and 260 or the wiper arm.

The connection holder 400 includes: an opening 410 which is formed in the center of the connection holder 400 and receives a portion of the adaptor 50, 150 and 250; and a first coupling portion 430 which is formed around the opening 410. The adaptor 50, 150 and 250 includes a second coupling portion 53, 153 and 253 to which the first coupling portion 430 is inserted in correspondence with the second coupling portion 53, 153 and 253. Any one of the first coupling portion 430 and the second coupling portion 53, 153 and 253 protrudes and the other is concave.

The wiper blade 1 may further include a seat part 420 which is formed around the opening 410 and on which the lower portion of the adaptor 50, 150 and 250 is seated.

The adaptor 50 and 150 may further include an arm coupling hole 51 and 151 which is formed therewithin and a central axis 52 and 152 which traverses the arm coupling hole 51 and 151 in the width direction of the adaptor 50 and 150. The connector 60 and 160 may include an axis coupling recess 61 and 161 which is coupled to the central axis 52 and 152 and a curved portion 62 and 162 which receives a U-hook type wiper arm.

The adaptor 150 may further include at least one pin hole 156a and 156b which is formed on the outside thereof and to which a side-pin hole type wiper arm is coupled. The connector 160 may further include at least one coupling recess 163a and 163b which contacts with the at least one pin hole 156a and 156b and receives a side fin of the side pin-hole type wiper arm.

The adaptor 250 may further include a pair of plate-shaped members 251 which face each other and protrude in parallel, a protrusion receiving recess 256 formed between the pair of plate-shaped members 251, and a fitting recess 257 formed within the pair of plate-shaped members 251. The connector 260 may include a body 262 including at least one catching portion 263 and 264 which is formed on both sides of the body 262 and by which the wiper arm is caught, and may further include a cover 261 limiting the movement of the wiper arm which is caught by the body 262. The body 262 may include a lower protrusion 265 which is inserted into the protrusion receiving recess 256, and a fitting part 266 which is inserted and coupled to the fitting recess 257.

A wiper arm which has a tap extending toward the cover while contacting with the upper surface and both sides of the wiper blade may be connected to the wiper blade. A wiper arm which has a cap contacting with the upper surface or side of the wiper blade may be connected to the wiper blade.

The connection holder 400 may be formed concave toward a wiper strip 10.

The main lever 40 may include a central fin 41 which forms an end 42 on at least a portion of the top of the main lever 40 and is integrally formed on the front outside surface of the main lever 40 such that it is overall concave toward the wiper strip 10. The central fin 41 may include a first fin 41a and a second fin 41b which are formed symmetrically with each other with respect to the connection holder 400.

The connection holder 400 may include a connection holder fin 440 which starts from the lower portion of the front outside surface of the connection holder 400 and meets an upper end 42 of the main lever 40 with the approach to both ends of the wiper blade 1.

Each of a pair of auxiliary levers 30 may include a side fin 31 which forms an end on at least a portion of the top of the auxiliary lever 30 and is integrally formed on the front outside surface of the auxiliary lever 30 such that it is overall concave toward the wiper strip 10. The side fins 31 may be formed symmetrically with respect to the connection holder 400.

### BRIEF DESCRIPTION OF THE DRAWINGS

FIG. 1 is a front view of a wiper blade according to an embodiment of the present invention;

FIG. 2 is a perspective view of the wiper blade according to the embodiment of the present invention;

FIGS. 3a and 3b are partial perspective view showing respectively one and the other ends of a wiper strip;

FIG. 4 is an exploded front view of the wiper blade according to the embodiment of the present invention;

FIG. 5 is an exploded perspective view of the wiper blade according to the embodiment of the present invention;

FIG. 6 is an exploded perspective view of a yoke lever and an auxiliary lever according to the embodiment of the present invention;

FIG. 7 is a perspective view of a main lever to which an adaptor and a connector to both of which a U-hook type wiper arm is coupled has been coupled in accordance with the embodiment of the present invention;

FIG. 8 is an exploded perspective view of the main lever to which the adaptor and the connector to both of which the U-hook type wiper arm is coupled has been coupled in accordance with the embodiment of the present invention;

FIG. 9 is an exploded bottom perspective view of the main lever to which the adaptor and the connector to both of which the U-hook type wiper arm is coupled has been coupled in accordance with the embodiment of the present invention;

FIG. 10 is a perspective view of the main lever to which the adaptor and the connector to both of which a side pin-hole type wiper arm is coupled has been coupled in accordance with another embodiment of the present invention;

FIG. 11 is an exploded perspective view of the main lever to which the adaptor and the connector to both of which the side pin-hole type wiper arm is coupled has been coupled in accordance with another embodiment of the present invention;

FIG. 12 is a perspective view of the main lever to which the adaptor and the connector to both of which an M lock type wiper arm and a top lock type wiper arm are coupled has been coupled in accordance with the embodiment of the present invention;

FIG. 13 is an exploded perspective view of the main lever to which the adaptor and the connector to both of which the top lock type wiper arm is coupled has been coupled in accordance with the embodiment of the present invention;

FIG. 14 is a front view of a top lock type connector according to the embodiment of the present invention;

FIG. 15 is a sectional perspective view obtained by cutting the main lever in a longitudinal direction in accordance with the embodiment of the present invention;

FIG. 16 is a perspective view for describing the coupling of the main lever and the auxiliary lever;

FIG. 17 is an enlarged view of the main lever of FIG. 16;

FIG. 18 is a front view of the wiper blade in which eight points of the wiper strip are supported;

FIG. 19 is an exploded perspective view of the wiper blade in which eight points of the wiper strip are supported; and

FIG. 20 is an exploded perspective view showing the auxiliary lever, a first yoke lever and a second yoke lever.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, exemplary embodiments of the present invention will be described in detail with reference to the accompanying drawings in order that the present invention may be easily implemented by those skilled in the art.

An overall configuration of a wiper blade assembly according to the present invention

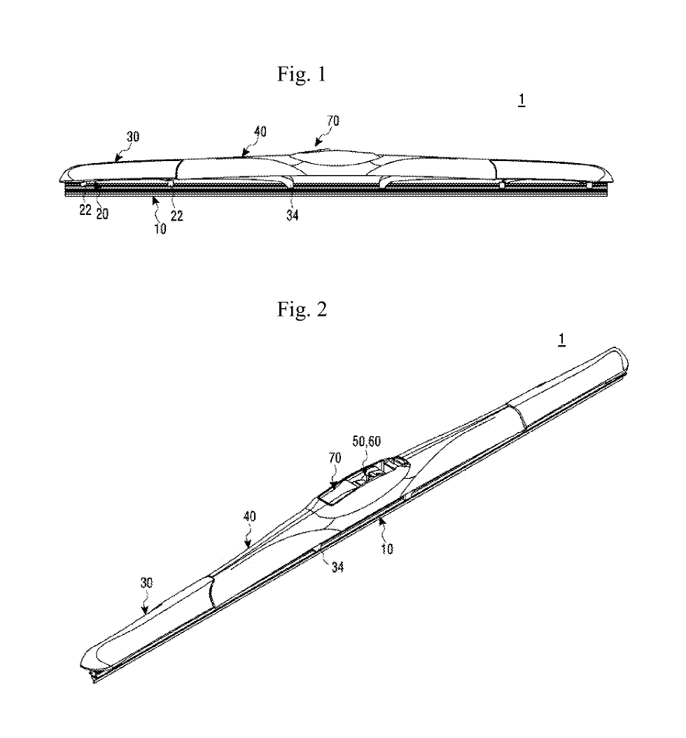

FIG. 1 is a front view of a wiper blade according to an embodiment of the present invention. FIG. 2 is a perspective view of the wiper blade according to the embodiment of the present invention.

Referring to FIGS. 1 and 2, a wiper blade 1 according to the present invention includes a wiper strip 10, a pair of yoke levers 20, a pair of auxiliary levers 30 and a main lever 40.

Hereafter, the wiper blade shown in FIGS. 1 and 2 will be described in detail.

As shown in FIGS. 1 and 2, the wiper blade 1 according to an embodiment of the present invention is connected to an end of a wiper arm and receives a pressing force from the wiper arm in a direction of a glass surface of a vehicle. The wiper arm rotates reciprocatively at a predetermined angle by a wiper motor (not shown). Accordingly, the wiper blade 1 wipes the glass surface (wiping surface) of the vehicle within the predetermined angle.

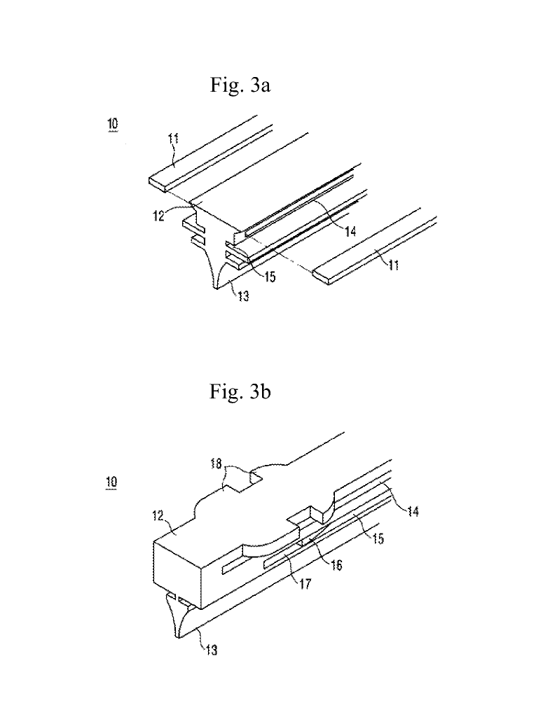

FIGS. 3a and 3b are partial perspective views showing respectively one and the other ends of the wiper strip.

Referring to FIGS. 1, 2, 3a and 3b, the wiper blade 1 further includes two backing plates 11 mounted on the wiper strip 10.

As shown in FIGS. 1, 2, 3a and 3b, the wiper strip 10 includes a wiping lip 13 and a base 12. The wiping lip 13 contacts directly with and wipes the glass surface. The base 12 is supported by the yoke lever 20 and the auxiliary lever 30. The wiper strip 10 is disposed to contact with the glass surface of the vehicle in a sliding manner and removes foreign substances on the glass surface. The wiper strip 10 extends in a longitudinal direction thereof and is made of either an elastic material like rubber or an elastic composite material.

The base 12 is supported by fasteners of the yoke lever 20 and the auxiliary lever 30. The fasteners may have a yoke shape. The base 12 and the wiping lip 13 continuously extend in a longitudinal direction of the wiper strip 10. A receiving recess 14 in which the two parallel backing plates 11 can be received extends in the base 12 in a longitudinal direction thereof. The two rectangular metallic backing plates 11 having spring characteristics are received in the two backing plate receiving recesses 14 respectively. A holding portion 15 receives the fastener in a sliding manner.

As shown in FIG. 3a, the holding portion 15 located at one end of the wiper strip 10 is open so as to receive the fastener. However, as shown in FIG. 3b, the other end of the wiper strip 10 is formed to limit the longitudinal movement of the fastener of any one of the pair of yoke levers 20. That is, the fastener supporting the other end is limited by a coupler 17 and a wall of a slope 16 provided only at the other end of the holding portion 15. Also, the longitudinal movement of the fastener is limited by a protrusion 18.

The backing plate 11 applies elasticity and rigidity to the wiping lip 13. When a pressing force is applied from the wiper arm, the pressing force is distributed to the wiper strip 10 through the levers. Here, the pressing force is distributed by the backing plate 11 in the longitudinal direction of the wiper strip 10. Accordingly, the backing plate 11 should have elasticity and rigidity to maintain the shape of the wiper strip 10. A plurality of the backing plates 11 and a plurality of the backing plate receiving recesses 14 may be provided according to the rigidity or elasticity of the wiper strip.

Next, an embodiment of the wiper blade according to the present invention will be described.

### <An Embodiment of the Wiper Blade According to the Present Invention >

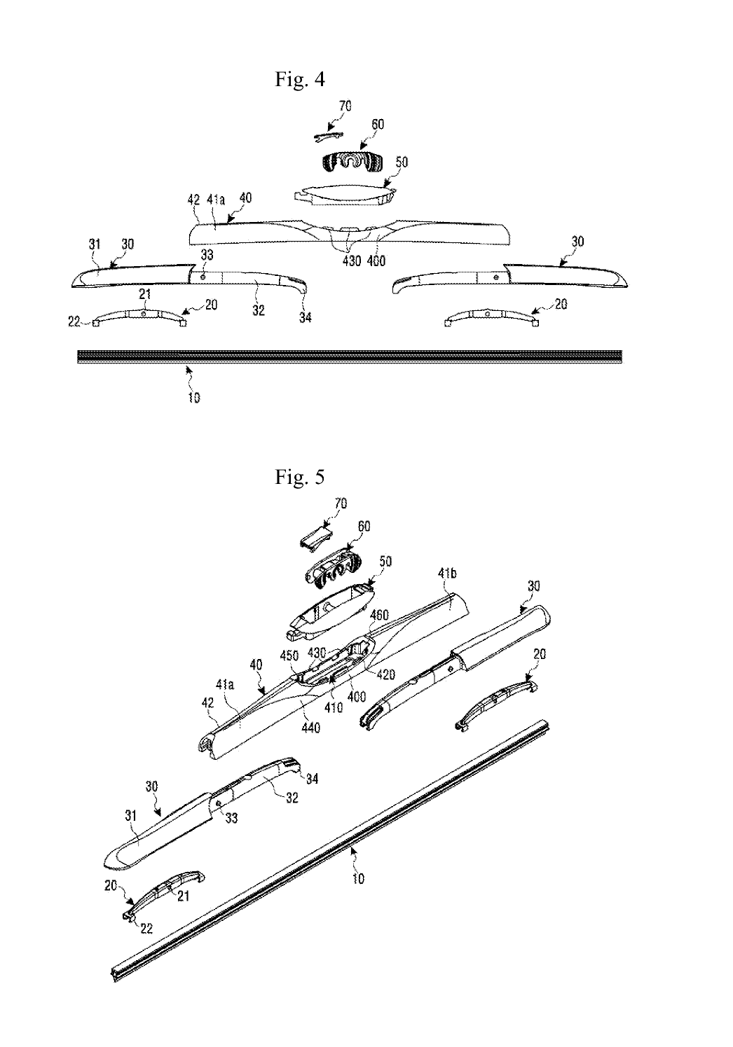

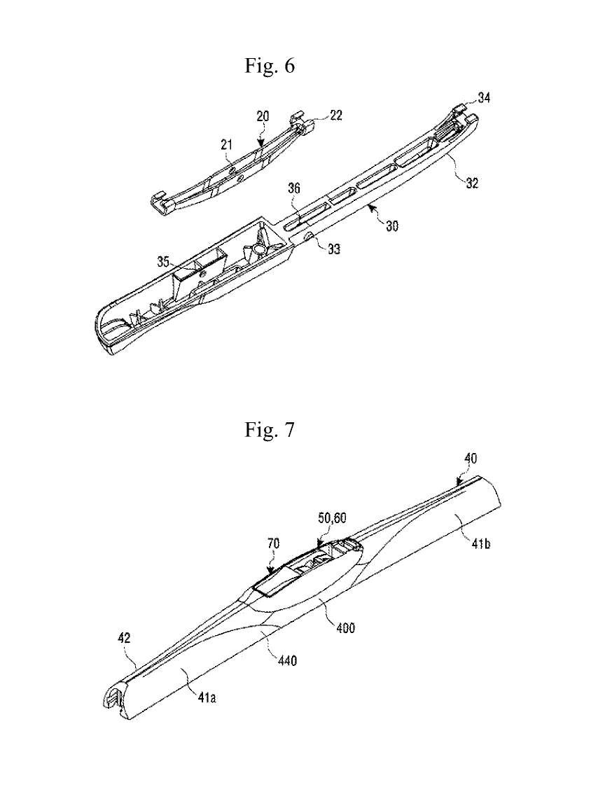

FIGS. 4 and 5 are an exploded front view and an exploded perspective view respectively of the wiper blade according to the embodiment of the present invention. FIG. 6 is an exploded perspective view of the yoke lever and the auxiliary lever according to the embodiment of the present invention.

Referring to FIGS. 4 and 5, the main lever 40 applies the pressing force applied from the wiper arm (not shown) to the auxiliary lever 30. The auxiliary lever 30 applies at least a portion of the pressing force to the yoke lever 20. The auxiliary lever 30 and the yoke lever 20 press the wiper strip 10, thereby allowing the wiper strip 10 to stably wipe the glass surface of the vehicle.

As shown in FIGS. 4 to 6, the yoke lever 20 presses the wiper strip 10 and supports the wiper strip 10 in such a manner as to be slidable. The yoke lever may include a catching recess 21 and a pair of fasteners 22. Although FIGS. 4 to 6 show that the yoke lever 20 is disposed on an end of the wiper strip 10, there is no limit to this. For example, the yoke lever 20 may be disposed apart from the end of the wiper strip 10 toward the center of the wiper strip 10. The yoke lever 20 may be made of a resin material and may be manufactured by an injection molding method.

The catching recess 21 of the yoke lever 20 may be formed on the side of the yoke lever 20. The catching recess 21 may be formed concave in a direction of the width of the yoke lever 20. A below-described catching protrusion 35 of the auxiliary lever 30 is coupled to the catching recess 21. The auxiliary lever 30 may perform a relative rotation with the yoke lever 20 about an axis of the catching recess 21.

The pair of fasteners 22 may be formed at both ends of the yoke lever 20. The fastener 22 may support the wiper strip 10 in such a manner as to be slidable.

As shown in FIGS. 4 to 6, the auxiliary lever 30 transfers the pressing force applied from the main lever 40 to the wiper strip 10 and the yoke lever 20. The auxiliary lever 30 may include a side fin 31, an extension part 32, a first hinge axis 33, a fastener 34, the catching protrusion 35, a second hinge axis 36, a rib 37, and a receiving hole 38. The fastener 34 is formed on one end of the auxiliary lever 30 and supports the wiper strip 10 in such a manner as to be slidable. The auxiliary lever 30 may be made of a resin material and may be manufactured by an injection molding method.

The side fin 31 is integrally formed with the top surface of a portion of the auxiliary lever 30. The side fin 31 may be implemented by processing the shape of the top surface of the auxiliary lever 30. Specifically, the side fin 31 may form the end on at least a portion of the top of the auxiliary lever 30, and may be formed on the front outside surface of the auxiliary lever 30 such that it is overall concave toward the wiper strip 10. When the wiping is performed, the side fin 31 induces air such that the air flowing toward the glass surface of the vehicle presses the auxiliary lever 30 in a direction closer to the glass surface of the vehicle. The side fin 31 may be coupled to the yoke lever 20 in such a manner as to perform a relative rotation with the yoke lever 20. The catching protrusion 35 which is caught by the catching recess 21 of the yoke lever 20 may be formed inside the side fin 31.

The extension part 32 is received within the lower portion of the main lever 40. One end of the extension part 32 may have the fastener 34. The first hinge axis 33 is formed on the outer surface of the extension part 32 and functions as a rotational axis at the time of performing a relative rotation with the main lever 40. The second hinge axis 36 may be formed within the extension part 32. The first hinge axis 33 and the second hinge axis 36 are coupled respectively to a below-described first hinge recess 44 and a below-described second hinge recess 46, both of which are formed within the main lever 40. Particularly, the first hinge axis 33 may be tapered such that the degree of protrusion of at least a portion of the first hinge axis 33 gradually increases or decreases. Therefore, since the first hinge axis 33 may be in an up and down direction coupled in a sliding manner to the first hinge recess 44 to be described below of the main lever 40, assemblability is improved. Further, the fastener 34 supporting the wiper strip 10 is provided at the end of the extension part 32, which is closer to the center of the wiper blade, in other words, at the other end of the auxiliary lever 30.

The receiving hole 38 into which a protrusion fitting portion 45 to be described below of the main lever 40 is inserted may be formed on the upper portion of the extension part 32. When the protrusion fitting portion 45 is inserted into the receiving hole 38, the gap between the auxiliary lever 30 and the main lever 40 is reduced and the torsional flow is prevented when the wiping is performed. By doing this, the rigidity of the resin-made lever can be enhanced.

The rib 37 is formed in the receiving hole 38 of the extension part 32 and interconnects the mutually facing inner walls of the receiving hole 38. During the process in which the auxiliary lever 30 is manufactured by the injection molding method and cured, the receiving hole 38 may be contracted inwardly. The rib 37 can prevent the receiving hole 38 from being contracted. The rib 37 may be received in a rib receiving recess 47 to be described below of the main lever 40.

The lower inside of the side fin 31 of the auxiliary lever 30 may be open to receive the yoke lever 20. The catching protrusion 35 to be coupled to the yoke lever 20 may be formed on the lower inside of the side fin 31 of the auxiliary lever 30. The catching protrusion 35 is caught by and coupled to the catching recess 21 formed on the side of the yoke lever 20.

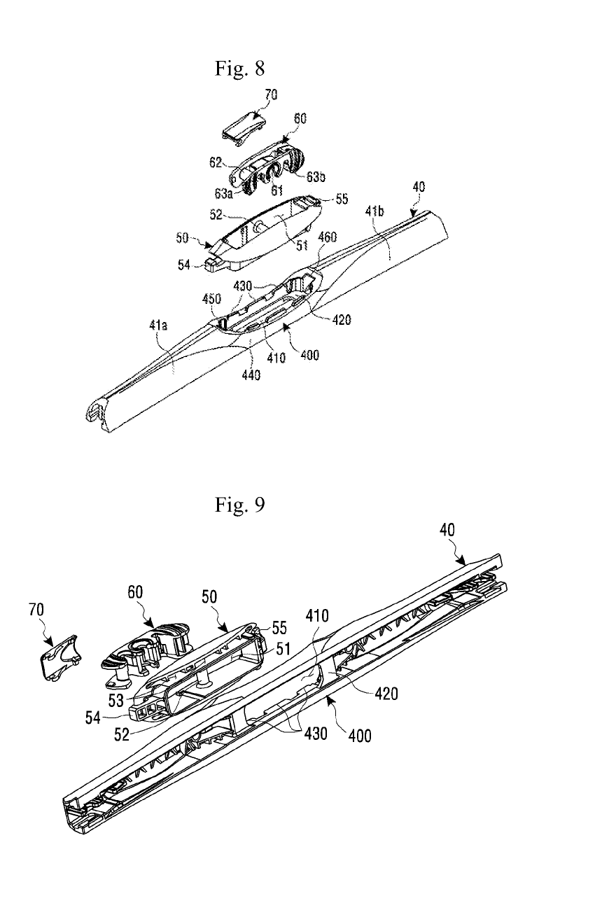

FIG. 7 is a perspective view of the main lever to which an adaptor and a connector to both of which a U-hook type wiper arm is coupled has been coupled in accordance with the embodiment of the present invention. FIG. 8 is an exploded perspective view of the main lever to which the adaptor and the connector to both of which the U-hook type wiper arm is coupled has been coupled in accordance with the embodiment of the present invention. FIG. 9 is an exploded bottom perspective view of the main lever to which the adaptor and the connector to both of which the U-hook type wiper arm is coupled has been coupled in accordance with the embodiment of the present invention.

Referring to FIGS. 1 to 9, the main lever 40 includes a connection holder 400 on which a below-described adaptor 50 is mounted, and a central fin 41 which forms an end 42 on at least a portion of the top of the main lever 40 and is integrally formed on the front outside surface of the main lever 40 such that it is overall concave toward the wiper strip 10. The central fin 41 may include a first fin 41a and a second fin 41b, both of which are formed on the left and right sides of the central fin 41 respectively when the wiper blade is viewed from the direction in which the traveling wind blows. According to the embodiment of the present invention, the first fin 41a and the second fin 41b may be symmetrical with each other with respect to the connection holder 400. Therefore, since the shapes of the first fin 41a and the second fin 41b are symmetrical with each other, the wiper blade according to the embodiment of the present invention can be applied to both of the left hand driver vehicle and the right hand driver vehicle. Also, in order that the wiper blade according to the embodiment of the present invention is applied to both of the left hand driver vehicle and the right hand driver vehicle, a direction in which the adaptor and the connector to both of which the wiper arm is connected are coupled may be selected.

As shown in FIGS. 7 to 9, the connection holder 400 may be placed in the central portion of the main lever 40. The connection holder 400 may be formed concave toward the wiper strip 10. The lower portion of the connection holder 400 does not receive the auxiliary lever 30 or the yoke lever 20. The connection holder 400 may have a trapezoidal shape or a U-shape. An opening 410 is formed in the center of the connection holder 400. A seat part 420 on which the bottom surface of the adaptor 50 is seated is formed around the opening 410. When the wiper blade 1 performs the wiping after the U-shaped wiper arm is coupled to the adaptor 50 and a connector 60, the connector 60 moves together with the wiper arm. Here, since the connection holder 400 has the opening 410, the connector 60 is able to move without being interfered up and down.

The seat part 420 may be formed to protrude toward the opening 410 from the inner surface of the connection holder 400. Also, the connection holder 400 may include a coupling protrusion 430 formed around the opening 410. The coupling protrusion 430 is inserted into a coupling recess 53 formed on the bottom surface of the adaptor 50. As a result, the adaptor 50 is mounted on the connection holder 400. The coupling protrusion 430 may be formed symmetrical with respect to the longitudinal centerline of the wiper blade and may include a plurality of protrusions. The plurality of protrusions may be spaced from each other. A first fitting recess 450 into which a first fitting part 54 formed on an end of the adaptor 50 is inserted may be formed on an end of the connection holder 400. A second fitting recess 460 into which a second fitting part 55 formed on the other end of the adaptor 50 is inserted may be formed on the other end of the connection holder 400. When the adaptor 50 is inserted downward into the connection holder 400, at least one of the coupling of the first fitting part 54 and the first fitting recess 450 and the coupling of the second fitting part 55 and the second fitting recess 460 may be an elastic coupling.

The lower portion of the front outside surface of the connection holder 400 may include a connection holder fin 440. The upper end of the connection holder fin 440 may form a portion of a curved line which starts from the lower portion of the connection holder 400 and meets the upper end of the main lever 40 with the approach to both ends of the wiper blade 1.

The adaptor 50 to be coupled to the connector 60 is provided within the connection holder 400. The corner of the opening 410 of the connection holder 400 has a shape having a curvature and transfers stress concentrated on the opening 410 of the connection holder 400 to the main lever 40.

Referring to FIGS. 7 to 9, the adaptor 50 to which the U-hook type wiper arm is coupled may include an arm coupling hole 51, a central axis 52, a catching recess 53, the first fitting part 54, and the second fitting part 55.

As shown in FIGS. 7 to 9, the adaptor 50 includes the arm coupling hole 51 formed therewithin, and the central axis 52 traversing the arm coupling hole 51 in the width direction of the adaptor 50. The wiper arm is received in and coupled to the arm coupling hole 51. The connector 60 which is directly connected to the wiper arm (not shown) is assembled to the central axis 52. Meanwhile, a cover member 70 may be coupled to the arm coupling hole 51.

The connector 60 to which the U-hook type wiper arm is coupled may include an axis coupling recess 61 which is coupled to the central axis 52 of the adaptor 50, and a curved portion 62 which receives the U-hook type wiper arm.

A variety of wiper arms can be coupled to the wiper blade 1. The shapes of the adaptor and the connector may be changed according to the shape of the wiper arm.

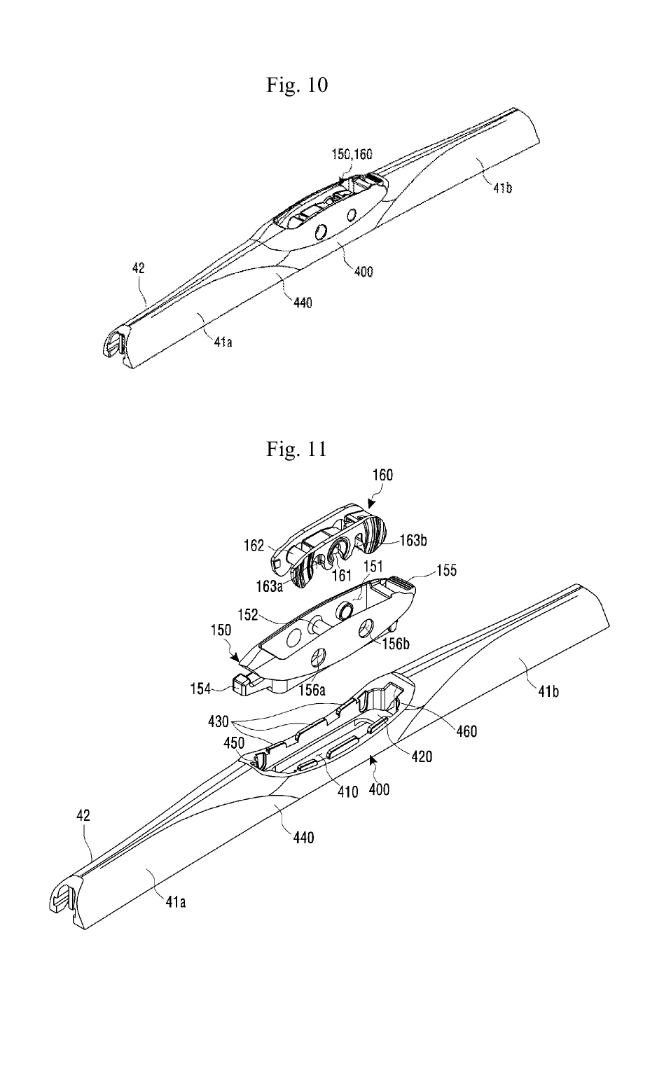

FIG. 10 is a perspective view of the main lever to which the adaptor and the connector to both of which a side pin-hole type wiper arm is coupled has been coupled in accordance with embodiment of the present invention. FIG. 11 is an exploded perspective view of the main lever to which the adaptor and the connector to both of which a side pin-hole type wiper arm is coupled has been coupled in accordance with embodiment of the present invention.

Referring to FIGS. 10 and 11, a side pin-hole type adaptor 150 may include the configurations of the above-described U-hook type adaptor 50 and may include one or more pin holes 156a and 156b formed on the side thereof for the coupling to the side pin-hole type wiper arm (not shown).

A side pin-hole type connector 160 includes the configurations of the above-described U-hook type adaptor 50 and further includes one or more coupling recesses 163a and 163b which contact with one or more pin holes 156a and 156b respectively and receive the side fin of the side pin-hole type wiper arm.

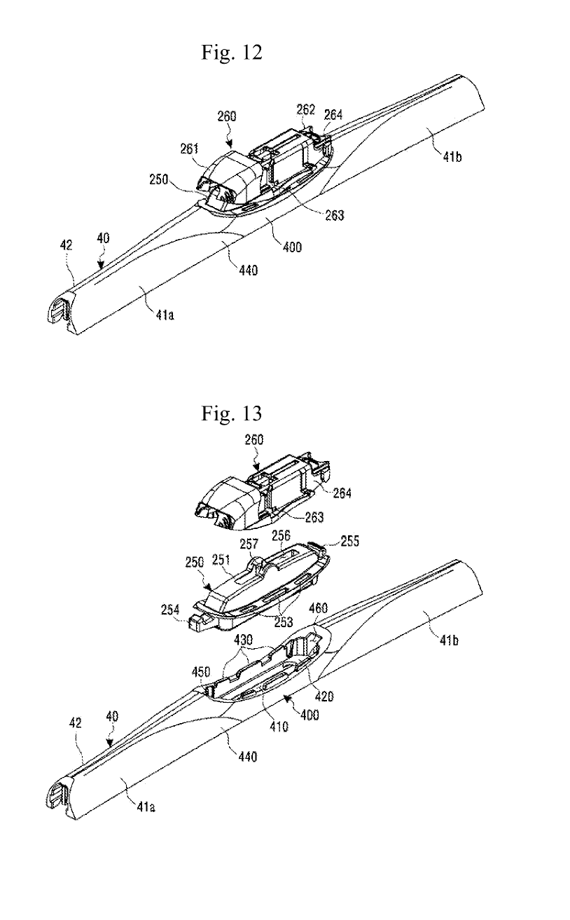

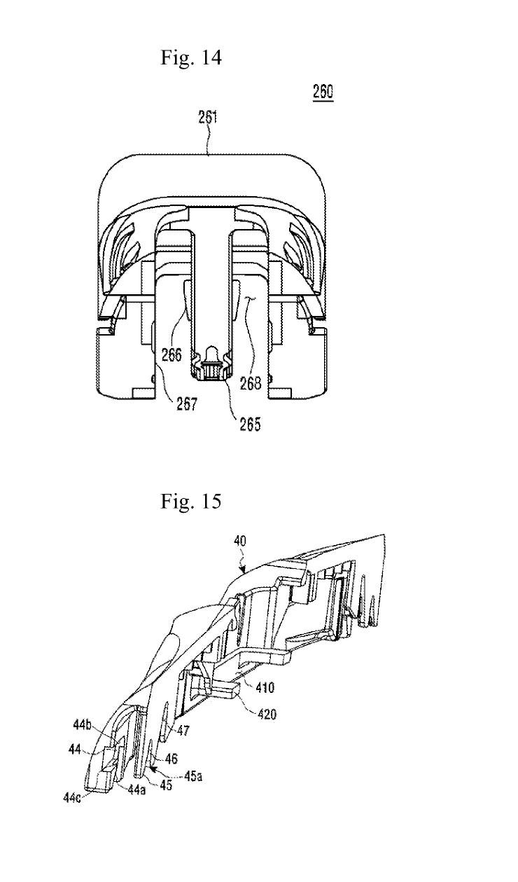

FIG. 12 is a perspective view of the main lever to which the adaptor and the connector to both of which a top lock type wiper arm is coupled has been coupled in accordance with the embodiment of the present invention. FIG. 13 is an exploded perspective view of the main lever to which the adaptor and the connector to both of which the top lock type wiper arm is coupled has been coupled in accordance with the embodiment of the present invention. FIG. 14 is a front view of a top lock type connector according to the embodiment of the present invention.

Referring to FIGS. 12 to 14, an adaptor 250 to which the top lock type wiper arm is coupled includes a pair of plate-shaped members 251 which face each other and protrude in parallel, a protrusion receiving recess 256 formed between the pair of plate-shaped members 251, a fitting recess 257 formed within the pair of plate-shaped members 251, and a coupling recess 253 which is inserted into the coupling protrusion 430 of the connection holder 400.

A connector 260 to which the top lock type wiper arm is coupled may include a body 262 and a cover 261. The body 262 includes one or more catching portions 263 and 264 which are formed on both sides of the body 262 and by which the top lock type wiper arm is caught. The cover 261 limits the movement of the wiper arm which is caught by the body 262. Also, as shown in FIG. 14, the body 262 includes a lower protrusion 265 which is inserted into the protrusion receiving recess 256, and a fitting part 266 which is inserted and coupled to the fitting recess 257.

As such, in the wiper blade according to the embodiment of the present invention, the shape of the couplable connector 60, 160 and 260 is changed according to the wiper arm, and the shape of couplable adaptor 50, 150 and 250 is changed according to the connector 60, 160 and 260. Accordingly, the connector 60, 160 and 260 and the adaptor 50, 150 and 250 which is mounted on the connection holder 400 of the wiper blade 1 can be selected according to the size or curvature of the glass surface of the vehicle. According to driver's seat position of the vehicle, the direction in which the adaptor 50, 150 and 250 is coupled to the connector 60, 160 and 260 can be changed. Since the shape of the fin of the wiper blade 1 is symmetrical, the wiper blade 1 is compatible with both a left hand drive vehicle and a right hand drive vehicle.

Hereafter, how the main lever is coupled to the auxiliary lever will be described.

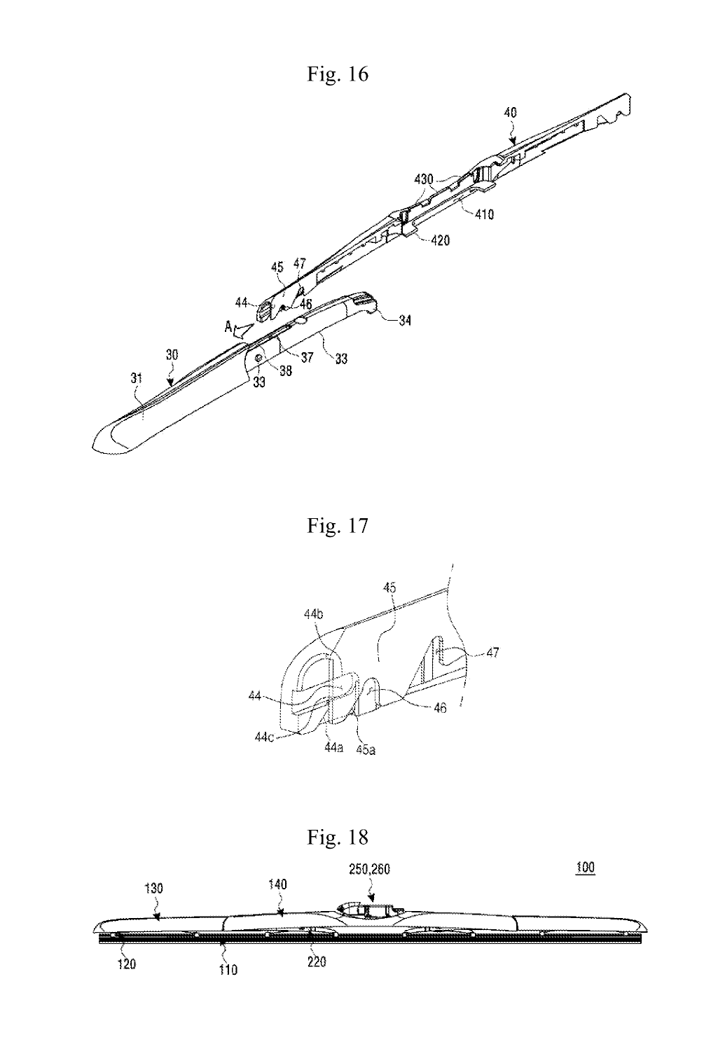

FIG. 15 is a sectional perspective view obtained by cutting the main lever in the longitudinal direction thereof in accordance with the embodiment of the present invention. FIG. 16 is a perspective view for describing the coupling of the main lever and the auxiliary lever. FIG. 17 is an enlarged view of the main lever of FIG. 16.

Referring to FIGS. 6 and 15 to 17, the bottom surface of the main lever 40 is open and receives the extension part 32 of the auxiliary lever 30. Both ends of the main lever 40 are able to perform a relative rotation with the auxiliary lever 30 and are separably coupled to the auxiliary lever 30. Specifically, the first hinge recess 44 and the second hinge recess 46 are formed in the main lever 40. The above-described first hinge axis 33 and the second hinge axis 36 of the auxiliary lever 30 may be coupled to the first and second hinge recesses 44 and 46 in a sliding manner in an obliquely up and down direction.

As shown in FIGS. 6 and 15 to 17, the end of the main lever 40 of the wiper blade 1 of the present invention may be formed to have a convex circular shape toward the end of the wiper blade 1. The end of the side fin 31 of the auxiliary lever 30, which is closer to the main lever 40, may be formed to have a concave circular shape toward the end of the wiper blade 1. The center of the curvature of at least a portion of the circular end of the main lever 40 is the same as that of at least a portion of the circular end of the side fin 31 of the auxiliary lever 30. Also, the centers of the curvature of the two circular ends may coincide with the first and second hinge axes 33 and 36. Therefore, when the main lever 40 and the auxiliary lever 30 are coupled to each other in the up and down direction perpendicular to the longitudinal direction of the wiper blade 1, the upper end of the side fin 31 of the auxiliary lever 30 causes interference with the lower end of the main lever 40. Accordingly, in the wiper blade 1 of the present invention, the auxiliary lever 30 and the main lever 40 may be coupled to each other in a sliding manner in the obliquely up and down direction.

Without a separate member, i.e., a spacer that is inserted between the main lever 40 and the auxiliary lever 30 for the coupling of the two levers, the two levers can be simply assembled in a sliding manner. The first hinge axis 33 and the second hinge axis 36 may function as a rotational axis of the relative rotation between the main lever 40 and the auxiliary lever 30.

In the foregoing, the wiper blade 1 having a six-point support structure has been described. However, the wiper blade according to the embodiment of the present invention can be also applied to a wiper blade which has an eight-point support structure having a pair of auxiliary levers and two pairs of yoke levers.

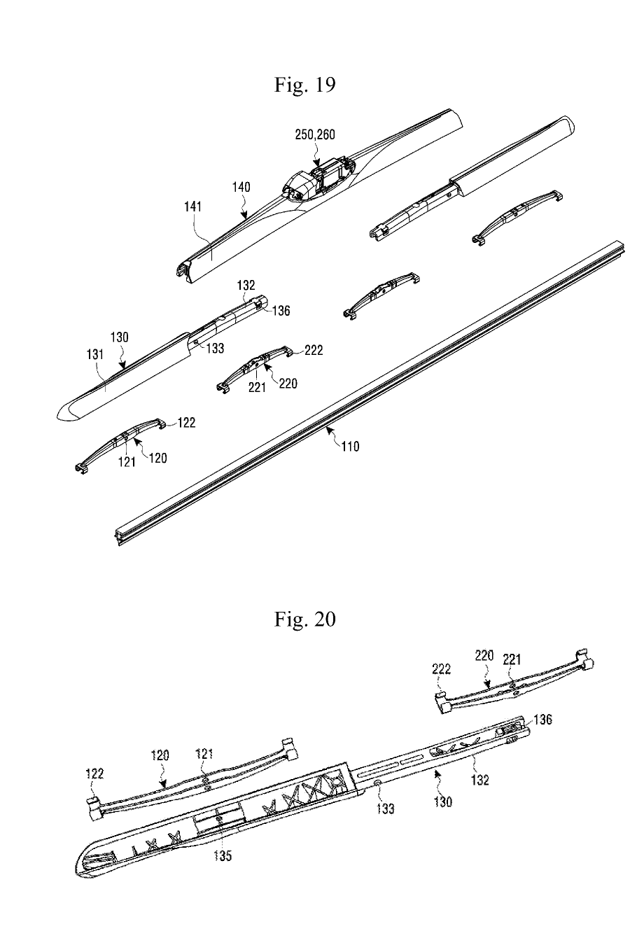

FIG. 18 is a front view of the wiper blade in which eight points of the wiper strip are supported. FIG. 19 is an exploded perspective view of the wiper blade in which eight points of the wiper strip are supported. FIG. 20 is an exploded perspective view showing the auxiliary lever, a first yoke lever and a second yoke lever.

Referring to FIGS. 18 to 20, the wiper blade according to the embodiment of the present invention may include a pair of first yoke levers 120 and a pair of second yoke levers 220. That is, a main lever 140 applies the pressing force applied from the wiper arm (not shown) to an auxiliary lever 130. The auxiliary lever 130 applies the pressing force to the first yoke lever 120 and the second yoke lever 220.

The lower inside of a side fin 131 of the auxiliary lever 130 may be open to receive the first yoke lever 120. A protrusion 135 to be coupled to the first yoke lever 120 may be formed on the lower inside of the side fin 131 of the auxiliary lever 130. The protrusion 135 is caught by and coupled to a catching recess 121 formed on the side of the first yoke lever 120.

A catching recess 221 of the second yoke lever 220 is formed on the side of the second yoke lever 220. The catching recess 221 may be formed concave in a direction of the width of the second yoke lever 220. A second catching protrusion 136 of the auxiliary lever 130 is coupled to the catching recess 221.

The pair of first yoke levers 120 and the pair of the second yoke levers 220 support four points of the wiper strip (not shown) respectively, so that they support the total of eight points of the wiper strip. The first and second yoke levers 120 and 220 press eight points of the wiper strip, thereby allowing the wiper strip to stably wipe the glass surface of the vehicle. When the size or curvature of the glass surface of the vehicle is increased, eight points of the wiper strip are supported and pressed by using the two pairs of the yoke levers. Accordingly, the wiper strip can be more stably and uniformly pressed than the wiper blade in which six points of the wiper strip are supported.

Consequently, the wiper blade 1 according to the embodiment of the present invention includes one main lever 40, a pair of auxiliary levers 30, and at least one pair of yoke levers 20. The main lever 40, the auxiliary lever 30 and the yoke lever 20 are formed symmetrically with respect to the longitudinal direction of the wiper blade. Also, according to driver's seat position of the vehicle on which the wiper blade is mounted, the direction in which the adaptor 50, 150 and 250 which is mounted on the wiper blade is coupled may be changed. The wiper blade 1 according to the embodiment of the present invention can be used in both a left hand drive vehicle and a right hand drive vehicle by changing the direction in which the adaptor 50, 150 and 250 is coupled to the connector 60, 160 and 260.

Each lever of the wiper blade 1 according to the embodiment of the present invention is made of a resin material.

According to the embodiment of the present invention, the levers which may be generally made of a metallic material are made of a resin material, thereby reducing the total weight of the wiper blade 1. When the levers are made of a resin material instead of a metallic material, the product can be integrally molded, and then the number of parts can be reduced. Accordingly, the process becomes simpler and manufacturing cost is reduced.

Particularly, without a separate member of the spacer that is inserted between the main lever 40 and the auxiliary lever 30, the wiper blade is assembled by using the recess and the catching structure of the protrusion. As a result, the number of the parts can be reduced and the wiper blade can be more simply assembled. Also, the levers are made of a resin material, so that the flexibility of the external appearance of the wiper blade 1 can be increased.

Although the foregoing has taken an example of the hybrid-type wiper blade including the cover in which the hybrid including the lever having the fin formed thereon has been formed, there is no limit to this. Therefore, the embodiment of the present invention can be also applied to a conventional type wiper blade or a flat type wiper blade.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A wiper blade 1 which is used in both a left hand drive vehicle and a right hand drive vehicle, the wiper blade comprising:
a connection holder which is formed in the central portion of the wiper blade and is connected to a wiper arm; and
an adaptor which is coupled to the connection holder and receives a connector connected directly to the wiper arm,
wherein the main lever is formed symmetrically with respect to the connection holder, and wherein a direction in which the adaptor is coupled to the main lever is selected according to the a steering wheel position of the vehicle.

2. The wiper blade of claim 1, wherein the adaptor is attachable to and detachable from the wiper blade and is replaceable according to the connector or the wiper arm.

3. The wiper blade of claim 1, wherein the connection holder comprises:
an opening which is formed in the center of the connection holder and receives a portion of the adaptor; and
a first coupling portion which is formed around the opening,
wherein the adaptor comprises a second coupling portion to which the first coupling portion is inserted in correspondence with the second coupling portion,
and wherein any one of the first coupling portion and the second coupling portion protrudes and the other is concave.

4. The wiper blade of claim 3, further comprising a seat part which is formed around the opening and on which the lower portion of the adaptor is seated.

5. The wiper blade of claim 3,
wherein the adaptor further comprises an arm coupling hole which is formed therewithin and a central axis which traverses the arm coupling hole in the width direction of the adaptor,
wherein the connector comprises an axis coupling recess which is coupled to the central axis and a curved portion which receives a U-hook type wiper arm.

6. The wiper blade of claim 5,
wherein the adaptor further comprises at least one pin hole which is formed on the outside thereof and to which a side-pin hole type wiper arm is coupled,
and wherein the connector further comprises at least one coupling recess which contacts with the at least one pin hole and receives a side fin of the side pin-hole type wiper arm.

7. The wiper blade of claim 3,
wherein the adaptor further comprises a pair of plate-shaped members which face each other and protrude in parallel, a protrusion receiving recess formed between the pair of plate-shaped members, and a fitting recess formed within the pair of plate-shaped members,
wherein the connector comprises a body comprising at least one catching portion which is formed on both sides of the body and by which the wiper arm is caught, and comprises a cover limiting the movement of the wiper arm which is caught by the body, and wherein the body comprises a lower protrusion which is inserted into the protrusion receiving recess, and a fitting part which is inserted and coupled to the fitting recess.

8. The wiper blade of claim 7,
wherein a wiper arm which has a tap extending toward the cover while contacting with the upper surface and both sides of the wiper blade is connected to the wiper blade,
or wherein a wiper arm which has a cap contacting with the upper surface or side of the wiper blade is connected to the wiper blade.

9. The wiper blade of claim 1, wherein the connection holder is formed concave toward a wiper strip.

10. The wiper blade of claim 1,
wherein the main lever comprises a central fin which forms an end on at least a portion of the top of the main lever and is integrally formed on the front outside surface of the main lever such that it is overall concave toward the wiper strip,
and wherein the central fin comprises a first fin and a second fin which are formed symmetrically with each other with respect to the connection holder.

11. The wiper blade of claim 1, wherein the connection holder comprises a connection holder fin which starts from the lower portion of the front outside surface of the connection holder and meets an upper end of the main lever with the approach to both ends of the wiper blade.

12. The wiper blade of claim 1, wherein each of a pair of auxiliary levers comprises a side fin which forms an end on at least a portion of the top of the auxiliary lever and is integrally formed on the front outside surface of the auxiliary lever such that it is overall concave toward the wiper strip, and wherein the side fins are formed symmetrically with respect to the connection holder.
